(19) United States
(12) Patent Application Publication
(10) Pub. No.: US 2012/0159444 A1
(43) Pub. Date: Jun. 21, 2012

(54) FUSING DEBUG INFORMATION FROM DIFFERENT COMPILER STAGES

(75) Inventors: Amit Kumar Agarwal, Bellevue, WA (US); Travis Paul Dorschel, Issaquah, WA (US); Paul Maybee, Seattle, WA (US)

(73) Assignee: Microsoft Corporation, Redmond, WA (US)

(21) Appl. No.: 12/971,943

(22) Filed: Dec. 17, 2010

(51) Int. Cl. G06F 9/44

(52) U.S. Cl. 717/124

(57) ABSTRACT

The present invention extends to methods, systems, and computer program products for fusing debug information from different compiler stages. Embodiments of the invention fuse debug information from a plurality of different compile stages in a code generation process into a single set of debug information. The single set of debug information maps directly between instructions and symbols (e.g., source code) input to a first compile stage and instructions and symbols (e.g., machine code) output from a last compile stage.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

To develop a software application for performing a computing task, a developer typically writes source code (e.g., in C++, Visual Basic, etc.) that expresses the desired functionality of the software application. The source code can then be compiled into executable code (or alternately interpreted at execution time). During source code compilation, a compiler converts source code instructions into machine instructions (e.g., x86 instructions) that are directly executable on a computer system. The executable code is run on a computer system to implement the desired functionality. Many compilers also output debug information that can assist a developer in locating and fixing defects in the source program causing deviation from desired functionality.

In some environments, a single stage compiler is used to compile source code into executable code. For example, a C++ compiler can compile C++ source code directly to executable code that can be run on a processor of a personal computer. In other environments, a multi-stage compiler is used to compile source code into executable code. A multi-stage compiler can include a number of different compile stages. Each compile stage can perform some translation, conversion, etc., to progress towards compiling received source code into machine instructions (e.g., targeted to a specific processor).

In more specific environments, Data Parallel C++ (“DPC++”) source code is developed to utilize a Graphical Processor Unit (“GPU”) in parallel with a Central Processing Unit (“CPU”) to implement desired functionality. That is, some source code is written to target the CPU and other source code written to target the GPU. For source code targeting the GPU, a multi-stage compiler is used to compile Data Parallel C++ (“DPC++) source code into High Level Shader Language (“HLSL”) byte code (which is executable on the GPU). A first compile stage translates DPC++ source code into HLSL source code. A second compile stage then converts the HLSL source code into HLSL bytecode for execution on the GPU. Use of the multi-stage compiler permits a DPC++ developer to develop code for the GPU without having to have knowledge of HLSL.

When a multi-stage compiler is used, each compilation stage typically outputs debug information mapping between instructions and symbols in an input format and instructions and symbols in an output format. For example, a first compile stage can output debug information mapping between source code instructions and symbols and intermediate code (e.g., second source code, intermediate language code, etc) instructions and symbols. A second compile stage can output debug information mapping between the intermediate code instructions and symbols and executable code instruction and symbols. Returning to the prior example, the first compile stage can output debug information mapping between DPC++ source code instructions and symbols and HLSL source code instructions and symbols. The second compile stage can output debug information mapping between HLSL source code instructions and symbols and HLSL bytecode instructions and symbols.

Thus, to debug an application that is compiled using a multi-stage compiler, a developer has to utilize a set of debug information from each compile stage to map a source code instruction or symbol to an executable code instruction or symbol. Processing multiple sets of debug information is resource intensive, and resource usage increases as the number of compile stages increases.

### BRIEF SUMMARY

The present invention extends to methods, systems, and computer program products for fusing debug information from different compiler stages. A first compilation stage accessing first code. The first code includes first instructions and first symbols in a first format. The first code is translated into second code. Translating the first code includes converting the first instructions and first symbols into corresponding second instructions and second symbols in a second format. The second format differs from the first format. Translating the first code also includes generating first debug information. The first debug information maps each instruction in the first instructions to a corresponding instruction in the second instructions and maps each symbol in the first symbols to a corresponding symbol in the second symbols.

A second compilation stage accesses the second code. The second code is translated into third code. Translating the second code includes converting the second instructions and second symbols into corresponding third instructions and third symbols in a third format. The third format differs from the first format and second format. Translating the second code also includes generating second debug information. The second debug information maps each instruction in the second instructions to a corresponding instruction in the third instructions and maps each symbol in the second symbols to a corresponding symbol in the third symbols.

The first debug information and the second debug information are fused into consolidated third debug information. The consolidated third debug information maps the first instructions directly to the third instructions and maps the first symbols directly to the third symbols. For each of the first instructions and first symbols, a second instruction or second symbol that corresponds to the first instruction or first symbol is identified from within the first debug information. A third instruction or third symbol that corresponds to the indentified second instruction or second symbol is identified from within the second debug information. The first instruction or first symbol is directly mapped to the identified corresponding third instruction or third symbol. The mapping of the first instruction or first symbol to the identified corresponding third instruction or third symbol is stored in the consolidated third debug information.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates fusing debug information from different compiler stages.

FIG. 2 illustrates another example computer architecture that facilitates fusing debug information from different compiler stages.

FIG. 3 illustrates a flow chart of an example method for fusing debug information from different compiler stages.

### DETAILED DESCRIPTION

The present invention extends to methods, systems, and computer program products for fusing debug information from different compiler stages. A first compilation stage accessing first code. The first code includes first instructions and first symbols in a first format. The first code is translated into second code. Translating the first code includes converting the first instructions and first symbols into corresponding second instructions and second symbols in a second format. The second format differs from the first format. Translating the first code also includes generating first debug information. The first debug information maps each instruction in the first instructions to a corresponding instruction in the second instructions and maps each symbol in the first symbols to a corresponding symbol in the second symbols.

A second compilation stage accesses the second code. The second code is translated into third code. Translating the second code includes converting the second instructions and second symbols into corresponding third instructions and third symbols in a third format. The third format differs from the first format and second format. Translating the second code also includes generating second debug information. The second debug information maps each instruction in the second instructions to a corresponding instruction in the third instructions and maps each symbol in the second symbols to a corresponding symbol in the third symbols.

The first debug information and the second debug information are fused into consolidated third debug information. The consolidated third debug information maps the first instructions directly to the third instructions and maps the first symbols directly to the third symbols. For each of the first instructions and first symbols, a second instruction or second symbol that corresponds to the first instruction or first symbol is identified from within the first debug information. A third instruction or third symbol that corresponds to the indentified second instruction or second symbol is identified from within the second debug information. The first instruction or first symbol is directly mapped to the identified corresponding third instruction or third symbol. The mapping of the first instruction or first symbol to the identified corresponding third instruction or third symbol is stored in the consolidated third debug information.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, flash drives, thumb drives, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In some embodiments, source code is developed to utilize a Graphical Processor Unit (“GPU”) in parallel within a Central Processing Unit (“CPU”) to implement desired functionality. That is, some source code is written to target the CPU and other source code written to target the GPU. For source code targeting a GPU, a multi-stage compiler can be used to compile source code into code that is executable on the GPU.

Generally, embodiments of the invention fuse debug information from a plurality of different compile stages in a code generation process into a single set of debug information. The single set of debug information maps directly between instructions and symbols (e.g., source code) input to a first compile stage and instructions and symbols (e.g., machine code) output from a last compile stage.

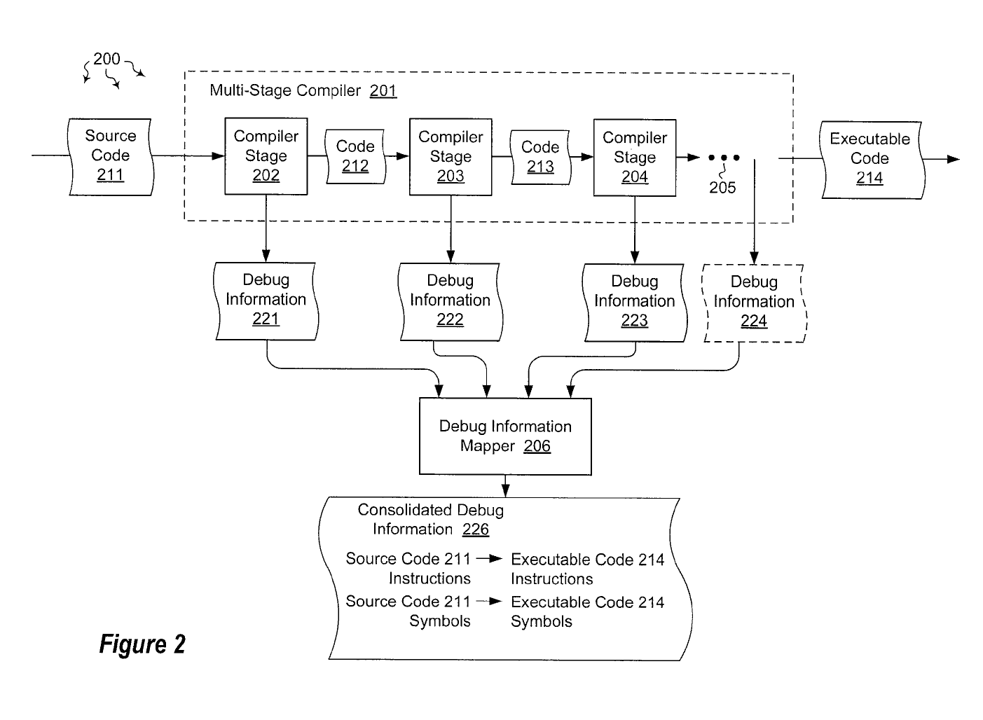

Referring initially to FIG. 2, FIG. 2 illustrates an example computer architecture 200 that facilitates fusing debug information from different compiler stages. Computer architecture 200 includes multi-stage compiler 201 and debug information mapper 206. Multi-stage compiler 201 includes a plurality of compiler stages, including compiler stages 202, 203, 204, etc. Ellipsis 205 represents that multi-state compiler 201 can include one or more additional compiler stages. Each of the depicted components can be connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Source code 211 (of virtually any programming language) can be provided as input to multi-stage compiler 201. Compiler stage 202 can receive source code 211. Compiler stage 202 can perform one or more: translate, convert, compile, etc, source code 211 to generate intermediate code 212. As part of the translation, conversion, compilation, etc., compile stage 202 can also generate debug information 221. Debug information 221 maps between instructions and symbols in source code 211 and instructions and symbols in intermediate code 212.

Compiler stage 203 can receive intermediate code 212. Compiler stage 203 can perform one or more: translate, convert, compile, etc, intermediate code 212 to generate intermediate code 212. As part of the translation, conversion, compilation, etc., compile stage 203 can also generate debug information 222. Debug information 222 maps between instructions and symbols in intermediate code 213 and instructions and symbols in intermediate code 214.

Compiler stage 204 can receive intermediate code 213. Compiler stage 204 can perform one or more: translate, convert, compile, etc, intermediate code 213 to generate further code (e.g., executable code 214 or further intermediate code that is passed to a next compiler stage). As part of the translation, conversion, compilation, etc., compile stage 204 can also generate debug information 223. Debug information 223 maps between instructions and symbols in intermediate code 213 and instructions and symbols in further code. When the further code is executable code 214, debug information 223 maps between instructions and symbols in intermediate code 213 and instructions and symbols in executable code 214.

When additional compiler stages are included in multi-stage compiler 201, these additional compiler stages can also generate debug information, such as, for example, debug information 224.

Debug information mapper 206 can receive debug information generated at the compile states of multi-stage compiler 201. For example, debug information mapper 206 can receive debug information 221, 222, 223, 224 (when present), etc. Debug information mapper 206 can fuse 221, 222, 223, 224 (when present), etc. into consolidated debug information 226. Consolidated debug information 226 maps directly between source code 211 instructions and executable code 214 instructions and maps directly between source code 211 symbols and executable code 214 symbols. As such, source code 211 can be more efficiently debugged when using consolidated debug information 226.

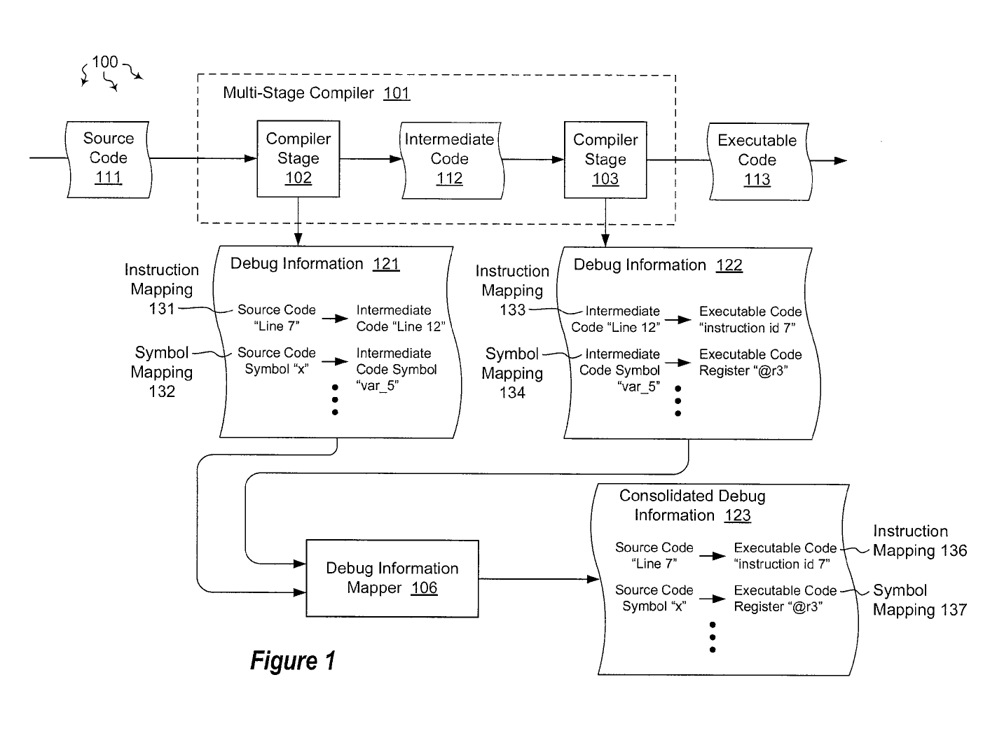

Turning now to FIG. 1, FIG. 1 illustrates an example computer architecture 100 that facilitates fusing debug information from different compiler stages. As depicted, computer architecture 100 includes multi-stage compiler 101 and debug information mapper 106. Multi-stage compiler 101 further includes compiler stage 102 and compiler stage 103. In general, multi-stage compiler 101 can receive input source code and compile the input source code into executable code. During compilation, each of compiler stages 102 and 103 can generate debug information.

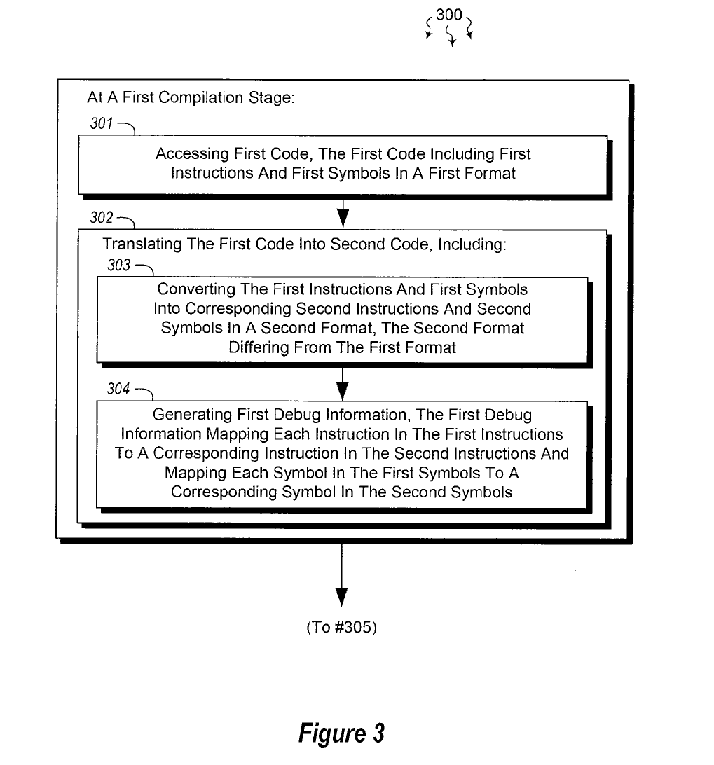

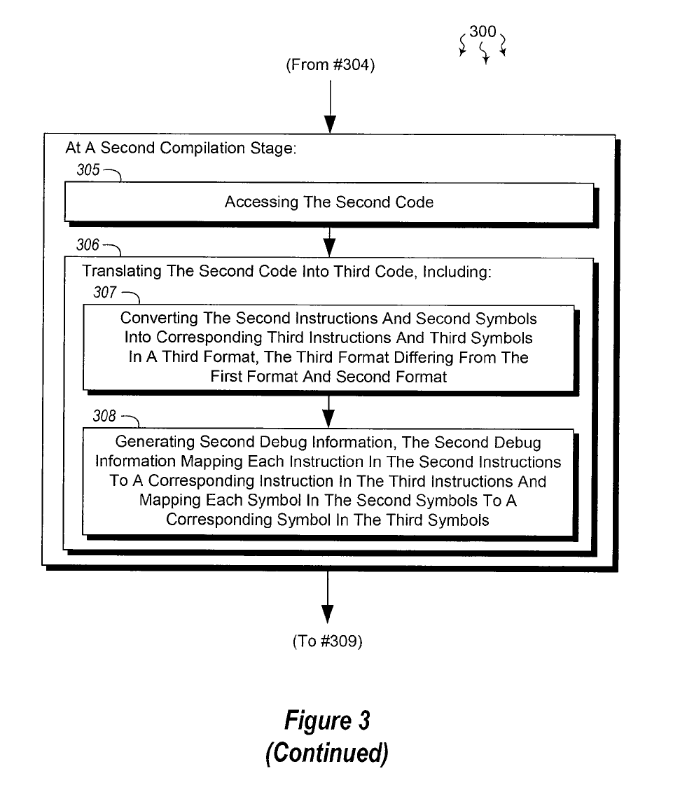

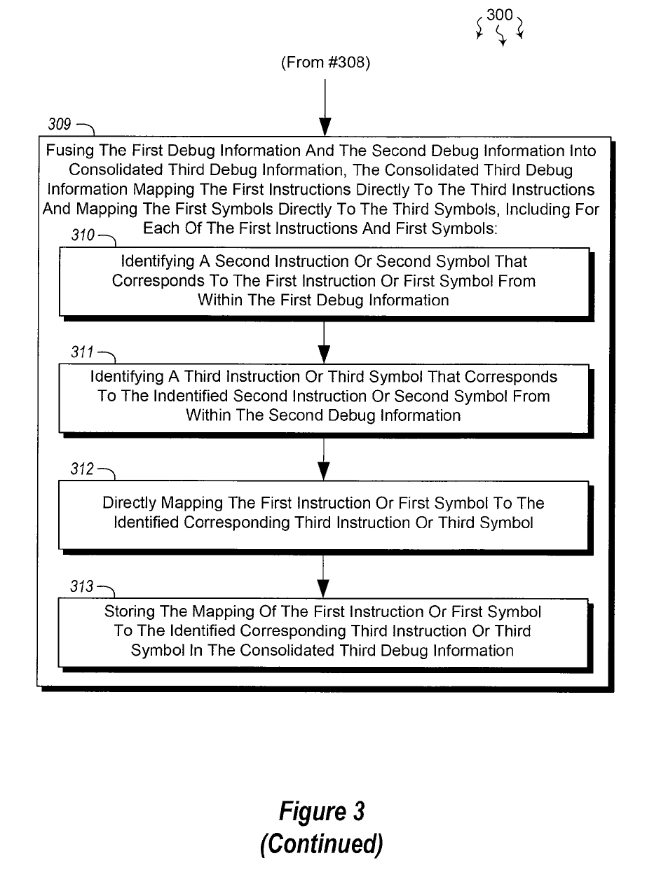

FIG. 3 illustrates a flow chart of an example method 300 for fusing debug information from different compiler stages. Method 300 will be described with respect to the components and data of computer architecture 100.

At a first compilation stage, method 300 includes an act of accessing first code, the first code including first instructions and first symbols in a first format (act 301). For example, compiler stage 102 can access source code 111. Source code 111 can include first instructions and first symbols in a first format (e.g., Data Parallel C++ (“DPC++”)).

Method 300 includes an act of translating the first code into second code (act 302). For example, compiler stage 102 can translate source code 111 into intermediate code 112. Act 302 includes an act of converting the first instructions and first symbols into corresponding second instructions and second symbols in a second format, the second format differing from the first format (act 303). For example, compiler stage 102 can convert instructions and symbols in source code 111 into corresponding instructions and symbols in intermediate code 112. The format of intermediate code 112 (e.g., High Level Shader Language (“HLSL”) source code) can differ from the formation of source code 111 (e.g., DPC++).

Act 302 includes act of generating first debug information, the first debug information mapping each instruction in the first instructions to a corresponding instruction in the second instructions and mapping each symbol in the first symbols to a corresponding symbol in the second symbol (act 304). For example, compiler stage 102 can generate debug information 121. Debug information 121 maps each instruction in source code 111 to a corresponding instruction in intermediate code 112. For example, instruction mapping 131 maps line 7 of source code 111 to line 12 of intermediate code 112. Debug information 121 also maps each symbol in source code 111 to a corresponding symbol in intermediate code 112. For example, symbol mapping 132 maps symbol x of source code 111 to symbol “var_{—}5’ of intermediate code 112.

At a second compilation stage, method 300 includes an act of accessing the second code (act 305). For example, compiler stage 103 can access intermediate code 112 (e.g., HLSL source code).

Method 300 includes an act of translating the second code into third code (act 306). For example, compiler stage 103 can translate intermediate code 112 into executable code 113. Act 306 includes an act of converting the second instructions and second symbols into corresponding third instructions and third symbols in a third format, the third format differing from the first format and second format (act 307). For example, compiler stage 103 can convert instructions and symbols in intermediate code 112 into corresponding instructions and symbols in executable code 113. The format of executable code 113 (e.g., HLSL bytecode) can differ from the format of source code 111 (e.g., DPC++) and intermediate code 112 (e.g., HLSL source code).

Act 306 includes an act of generating second debug information, the second debug information mapping each instruction in the second instructions to a corresponding instruction in the third instructions and mapping each symbol in the second symbols to a corresponding symbol in the third symbols (act 308). For example, compiler stage 103 can generate consolidated debug information 123. Consolidated debug information 123 maps each instruction in intermediate code 112 to a corresponding instruction in executable code 113. For example, instruction mapping 133 maps line 12 of intermediate code 112 to instruction id 7 of executable code 117. Consolidated debug information 123 also maps each symbol in intermediate code 112 to a corresponding symbol in executable code 113. For example, symbol mapping 134 maps symbol var_5 of intermediate code 112 to register @r3 of executable code 113.

Method 300 includes an act of fusing the first debug information and the second debug information into third debug information, the third debug information mapping the first instructions directly to the third instructions and mapping the first symbols directly to the third symbols (act 309). For example, debug mapper 106 can fuse debug information 121 and debug information 122 into consolidated debug information 123. Consolidated debug information 123 directly maps between instruction in source code 111 and instructions in executable code 113. Consolidated debug information 123 also directly maps between symbols in source code 111 and symbols in executable code 113.

For each of the first instructions and first symbols, act 309 includes an act of identifying a second instruction or second symbol that corresponds to the first instruction or first symbol from within the first debug information (act 310). For example, debug mapper 106 can identify that line 12 of intermediate code 112 corresponds to line 7 of source code 111. Similarly, debug mapper 106 can identify that symbol var_5 of intermediate code 112 corresponds to symbol x of source code 111.

For each of the first instructions and first symbols, act 309 includes an act of identifying a third instruction or third symbol that corresponds to the indentified second instruction or second symbol from within the second debug information (act 311). For example, debug mapper 106 can identify that instruction id 7 of executable code 113 corresponds to line 12 of intermediate code 112. Similarly, debug mapper 106 can identify that register @r3 of executable code 133 corresponds to symbol var_5 of intermediate code 112.

For each of the first instructions and first symbols, act 309 includes an act of directly mapping the first instruction or first symbol to the identified corresponding third instruction or third symbol (act 312). For example, debug mapper 106 can formulate instruction mapping 136 to map directly between line 7 of source code 111 and instruction id 7 of executable code 113. Similarly, debug mapper can formulate symbol mapping 137 to map directly between symbol x of source code 111 and register @r3 of executable code 113. For each of the first instructions and first symbols, act 309 includes an act of storing the mapping of the first instruction or first symbol to the identified corresponding third instruction or third symbol in the third debug information (act 313). For example, debug mapper 106 can store instruction mapping 136 and symbol mapping 137 in consolidated debug information 123.

Consolidated debug information 123 can then be used at a debug module (not shown) to assist in debugging source code 111.

Some embodiments of the invention more specifically related to compiling DPC++ code into HLSL bytecode for execution at a Graphical Processing Unit (“GPU”). A first compile stage generates flattened HLSL source level compute shaders corresponding to each DPC++ forall call site. A second compile stage invokes an HLSL compiler to generate HLSL bytecode corresponding to the HLSL source level compute shaders generated. The generated bytecodes for each kernel invocation at a forall call site are thereafter stored within the text segment of the compiler generated PE (portable executable) executable.

At each compilation stage, a set of symbolic mappings are generated. The symbolic mappings represent the translation performed as part of that compilation stage. The first compilation stage defines mappings between DPC++ source symbols and generated HLSL source code symbols. The second compilation stage defines mappings between the HLSL source code symbols and the corresponding locations (bytecode addresses, registers) in the final HLSL bytecode.

To facilitate debug efficiencies and a reduced memory footprint, symbolic debug information can be fused into a single set of records that provide a direct mapping between DPC++ source symbols and the final HLSL bytecode for the following reasons. A single set of mappings enables a compiler to strip off the intermediate HLSL to bytecode symbolic mapping information from the HLSL bytecode blob (which is stored in the PE executable) thus reducing the memory footprint of the executable. Further, a single set of symbolic debug info records both simplify and expedite DPC++ symbol resolution in the GPU debugger by enabling direct mapping between the source symbols and location and HLSL bytecode addresses and registers (instead of a two level mapping from DPC++ source to HLSL source followed by HLSL source to bytecode mappings and vice versa).

For example, a first compiler stage can be used to translate example DPC++ code:

void int_add_kernel(...)
{

...
c = a + b; // Line 11

}

into the example, HLSL source code:

void hlsl_int_add_kernel(...)
{

...
var_2 = var_1 + var_0; // Line 24

}

Subsequently, a second compiler stage compiles the example, HLSL source code into example HLSL bytecode:

...
@r2 = @r1 + @r0 // Instruction index 5

When generating HLSL source code in the compiler backend, the mappings from code tuples and symbols to HLSL source locations and symbol names can be stored in some internal data structures, such as, for example, Program Database (PDB) records. For example, the first compiler stage can generate a first internal data structure that maps DPC++ source code instructions and symbols to HLSL source code instructions and symbols.

DPC++ “line 11”->HLSL “line 24”

DPC++ symbol “a”->HLSL symbol “var_{—}0”

DPC++ symbol “b”->HLSL symbol “var_{—}1”

DPC++ symbol “c”->HLSL symbol “var_{—}2”

Subsequently, the second compiler stage can generate a second internal data structure that maps HLSL source code instructions and symbols to HLSL bytecode.

HLSL “line 24”->Bytecode “instruction id 5”

HLSL symbol “var_{—}0”->Bytecode register “@r0”

HLSL symbol “var_{—}1”->Bytecode register “@r1”

HLSL symbol “var_{—}2”->Bytecode register “@r2”

A reader component can be implemented to read the second internal data structure and resolve HLSL source locations and symbols to bytecode addresses & registers. Next, the first internal data structure is used to generate direct mappings between DPC++ source locations and symbols and HLSL bytecode addresses and register names. The direct mappings can be stored in a third internal data structure, such as, for example, in the form of PDB records.

DPC++“line 11”->Bytecode “instruction id 5”

DPC++ symbol “a”->Bytecode register “@r0”

DPC++ symbol “b”->Bytecode register “@r1”

DPC++ symbol “c”->Bytecode register “@r2”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. On a computer system including one or more processors and system memory, the computer system also including a multi-stage compiler for compiling source code into executable code, the multi-stage compiler having a plurality of compilation stages including at least a first compilation stage and a second compilations stage, each compilation stage in the plurality of compilation stages configured to convert between code formats and make progress towards generating executable code from source code, a method for combining debug information generated at different compilation stages, the method comprising:
an act of fusing first debug information and second debug information into consolidated third debug information,
the first debug information generated at the first compilation stage that translates first code in a first format into second code in a second different format, the first debug information mapping each instruction in the first code to a corresponding instruction in the second code and mapping each symbol in the first code to a corresponding symbol in the second code,
the second debug information generated at the second compilation stage that translates the second code into third code in a third different format, the second debug information mapping each instruction in the second code to a corresponding instruction in the third code and mapping each symbol in the second code to a corresponding symbol in the third code,
the consolidated third debug information mapping the first instructions directly to the third instructions and mapping the first symbols directly to the third symbols, fusing the first debug information and the second debug information including for each instruction and symbol in the first code:
an act of using the first debug information to identify an instruction or symbol in the second code that corresponds to the instruction or symbol in the first code;
an act of using the second debug information to identify an instruction or symbol in the third code that corresponds to the identified instruction or symbol in the second code;
an act of directly mapping the instruction or symbol in the first code to the identified corresponding instruction or symbol in the third code; and
an act of storing the direct mapping of the instruction or symbol in the first code to the instruction or symbol in the third code in the consolidated third debug information.

2. The method as recited in claim 1, wherein the act of fusing the first debug information and the second debug information into consolidated third debug information comprises an act of fusing first debug information that maps between instruction locations and symbols in Data Parallel C++ (DPC++) source code and instruction locations and symbols in High Level Shader Language (HLSL) source code and second debug information that maps between instruction locations and symbols in HLSL source code and addresses and register names in HLSL bytecode into consolidated third debug information that maps between locations and symbols in the DPC++ source code and addresses and register names in the HLSL bytecode.

3. The method as recited in claim 1, wherein the first compilation stage is configured to translate Data Parallel C++ (DPC++) source code into High Level Shader Language (HLSL) source code.

4. The method as recited in claim 1, wherein the second compilation stage is configured to translate High Level Shader Language (HLSL) source code into HLSL bytecode.

5. The method as recited in claim 1, wherein the first, second, and consolidated third debug information is stored as program database (PDB) records.

6. The method as recited in claim 1, further comprising an act of using consolidated third debug information to assist in debugging the first code.

7. A computer program product for use at a computer system, the computer system including a multi-stage compiler for compiling source code into executable code, the multi-stage compiler having a plurality of compilation stages including at least a first compilation stage and a second compilations stage, each compilation stage in the plurality of compilation stages configured to convert between code formats and make progress towards generating executable code from source code, the computer program product for implementing a method for combining debug information generated at different compilation stages, the computer program product comprising one or more computer storage devices having stored thereon computer-executable instructions that, when executed at a processor, cause the computer system to perform the method, including the following:
fuse first debug information and second debug information into consolidated third debug information,
the first debug information generated at the first compilation stage that translates first code in a first format into second code in a second different format, the first debug information mapping each instruction in the first code to a corresponding instruction in the second code and mapping each symbol in the first code to a corresponding symbol in the second code,
the second debug information generated at the second compilation stage that translates the second code into third code in a third different format, the second debug information mapping each instruction in the second code to a corresponding instruction in the third code and mapping each symbol in the second code to a corresponding symbol in the third code,
the consolidated third debug information mapping the first instructions directly to the third instructions and mapping the first symbols directly to the third symbols, fusing the first debug information and the second debug information including for each instruction and symbol in the first code:
an act of using the first debug information to identify an instruction or symbol in the second code that corresponds to the instruction or symbol in the first code;
an act of using the second debug information to identify an instruction or symbol in the third code that corresponds to the identified instruction or symbol in the second code;
an act of directly mapping the instruction or symbol in the first code to the identified corresponding instruction or symbol in the third code; and
an act of storing the direct mapping of the instruction or symbol in the first code to the instruction or symbol in the third code in the consolidated third debug information.

8. The computer program product as recited in claim 7, wherein computer-executable instructions that, when executed, cause the computer system to fuse the first debug information and the second debug information into the consolidated third debug information comprise computer-executable instructions that, when executed, cause the computer system to fuse first debug information that maps between instruction locations and symbols in Data Parallel C++ (DPC++) source code and instruction locations and symbols in High Level Shader Language (HLSL) source code and second debug information that maps between instruction locations and symbols in HLSL source code and addresses and register names in HLSL bytecode into consolidated third debug information that maps between locations and symbols in the DPC++ source code and addresses and register names in the HLSL bytecode.

9. The computer program product as recited in claim 7, wherein the first compilation stage is configured to translate Data Parallel C++ (DPC++) source code into High Level Shader Language (HLSL) source code.

10. The computer program product as recited in claim 7, wherein the second compilation stage is configured to translate High Level Shader Language (HLSL) source code into HLSL bytecode.

11. The computer program product as recited in claim 7, wherein the first, second, and consolidated third debug information is stored as program database (“PDB”) records.

12. The computer program product as recited in claim 7, further comprising computer-executable instructions that, when executed, cause the computer system to use the consolidated third debug information to assist in debugging the first code.

13. At a computer system including one or more processors and system memory, the computer system also including a multi-stage compiler for compiling source code into executable code, the multi-stage compiler having a plurality of compilation stages, each compilation stage in the plurality of compilation stages configured to convert between code formats and make progress towards generating executable code from source code, a method for combining debug information generated at different compilation stages, the method comprising:
at a first compilation stage:
an act of accessing first code, the first code including first instructions and first symbols in a first format;
an act of translating the first code into second code, including:
an act of converting the first instructions and first symbols into corresponding second instructions and second symbols in a second format, the second format differing from the first format; and
an act of generating first debug information, the first debug information mapping each instruction in the first instructions to a corresponding instruction in the second instructions and mapping each symbol in the first symbols to a corresponding symbol in the second symbols;
at a second compilation stage:
an act of accessing the second code;
an act of translating the second code into third code, including:
an act of converting the second instructions and second symbols into corresponding third instructions and third symbols in a third format, the third format differing from the first format and second format; and
an act of generating second debug information, the second debug information mapping each instruction in the second instructions to a corresponding instruction in the third instructions and mapping each symbol in the second symbols to a corresponding symbol in the third symbols;
an act of fusing the first debug information and the second debug information into consolidated third debug information, the consolidated third debug information mapping the first instructions directly to the third instructions and mapping the first symbols directly to the third symbols, including for each of the first instructions and first symbols:
an act of identifying a second instruction or second symbol that corresponds to the first instruction or first symbol from within the first debug information;
an act of identifying a third instruction or third symbol that corresponds to the indentified second instruction or second symbol from within the second debug information; and
an act of directly mapping the first instruction or first symbol to the identified corresponding third instruction or third symbol;
an act of storing the mapping of the first instruction or first symbol to the identified corresponding third instruction or third symbol in the consolidated third debug information.

14. The method as recited in claim 13, wherein the act of converting the first instructions and first symbols into corresponding second instructions and second symbols in a second format comprises an act of converting Data Parallel (DPC++) source code to High Level Shader Language (HLSL) source code.

15. The method as recited in claim 14, wherein the act of generating first debug information comprises an act of generating debug information that maps instructions and symbols in the Data Parallel C++ (DPC++) source to instructions and symbols in the High Level Shader Language (HLSL) source code.

16. The method as recited in claim 13, wherein the act of converting the second instructions and second symbols into corresponding third instructions and third symbols in a third format comprises an act of converting High Level Shader Language (HLSL) source code to HLSL byte code.

17. The method as recited in claim 16, wherein the act of generating second debug information comprises an act of generating debug information that maps instructions and symbols the High Level Shader Language (HLSL) source code to address and registers in the HLSL bytecode.

18. The method as recited in claim 13, wherein the an act of accessing first code comprises an act of access source code of a general purpose programming language, the source code configured for parallel execution on a central processing unit (CPU) and a graphical processing unit (GPU).

19. The method as recited in claim 13, wherein the act of converting the second instructions and second symbols into corresponding third instructions and third symbols in a third format comprises an act of converting the second instructions and second symbols into code that is executable on a Graphical Processing Unit (“GPU”).

20. The method as recited in claim 13, wherein the act of fusing the first debug information and the second debug information into the consolidated third debug information comprises an act of fusing first debug information that maps between instruction locations and symbols in Data Parallel C++ (DPC++) source code and instruction locations and symbols in High Level Shader Language (HLSL) source code and second debug information that maps between instruction locations and symbols in HLSL source code and addresses and register names in HLSL bytecode into third debug information that maps between locations and symbols in the DPC++ source code and addresses and register names in the HLSL bytecode.
